(19) United States
(12) Patent Application Publication
(10) Pub. No.: US 2010/0313563 A1
(43) Pub. Date: Dec. 16, 2010

(54) HYDRAULIC ENGINE

(76) Inventor: Richard C. Gronback, Westbrook, CT (US)

Correspondence Address: MCCORMICK, PAULDING & HUBER LLP, CITY PLACE II, 185 ASYLUM STREET, HARTFORD, CT, 06103, US

(21) Appl. No.: 12/482,510

(22) Filed: Jun. 11, 2009

(51) Int. Cl. F03G 3/04; F16D 31/02

(52) U.S. Cl. 60/639; 60/398

(57) ABSTRACT

A gravity driven hydraulic engine that includes an outer shell having first and second ends and an inner cavity that is substantially impervious to water. The engine further includes at least one cylinder, having opposing first and second ends, located within the inner cavity. The engine also includes a weighted piston within the cylinder which divides the cylinder into first and second chambers. The weighted piston is slidably movable within the cylinder. In use, the first and second chambers alternately fill with liquid and air causing movement of the engine thereby generating energy output.

### FIELD OF THE INVENTION

The present invention relates to hydraulic engine and, more particularly, to a hydraulic engine driven by gravity.

### BACKGROUND OF THE INVENTION

As will be readily appreciated, many conventional engines use fossil fuels to operate. Other engines utilize wood, solar or nuclear power. The drawbacks of these power sources are well known, e.g., depletion of essentially finite resources, undesirable emissions and waste products, and reliability issues. Moreover, such engines are often quite complex and expensive to manufacture.

Accordingly, a need exists for a relatively simple, easy to manufacture engine that requires no fuel, produces no emissions and is easily scalable for different applications. There is also a need for an engine that can run constantly and is nearly silent in operation. As described herein, the inventive hydraulic engine addresses these needs.

### SUMMARY OF THE INVENTION

It is an object of the present invention to provide a hydraulic engine.

It is an additional object of the present invention to provide a hydraulic engine that is gravity driven.

It is another object of the present invention to provide a gravity driven hydraulic engine that requires no fuel to operate.

It is yet another object of the present invention to provide a gravity driven hydraulic engine that produces zero emissions.

It is another object of the present invention to provide a gravity driven hydraulic engine that runs constantly.

It is an additional object of the present invention to provide a gravity driven hydraulic engine that is scalable.

It is yet another object of the present invention to provide a gravity driven hydraulic engine that is nearly silent in operation.

It is another object of the present invention to provide a gravity driven hydraulic engine that may be easily constructed using basic mechanical materials.

An embodiment of the inventive gravity driven hydraulic engine includes an outer shell having first and second ends and an inner cavity that is substantially impervious to water. The engine further includes at least one cylinder, having opposing first and second ends, located within the inner cavity. The engine also includes a weighted piston within the cylinder which divides the cylinder into first and second chambers. The weighted piston is slidably movable within the cylinder. In use, the first and second chambers alternately fill with liquid and air to cause the engine become negatively buoyant and sink and also to become positively buoyant and rise. As the engine sinks, it rotates pulleys, which, in turn, generates energy output.

An embodiment of the inventive method of generating energy output in an aqueous environment involves placing a hydraulic engine in an aqueous environment. Once in the environment, a negative buoyancy is created within the hydraulic engine to submerge the engine in the aqueous environment. As the submerged hydraulic engine sinks, it rotates pulleys generating energy output. The engine then achieves positive buoyancy to rise in the aqueous environment where it is rotated to reset it to its starting position.

These and other objects, features and advantages of the present invention will become apparent in light of the detailed description of the best mode embodiment thereof, as illustrated in the accompanying drawings.

### DESCRIPTION OF THE DRAWINGS

FIG. 1 is a schematic elevation view of a gravity driven hydraulic engine according to an embodiment of the present invention.

FIG. 2 is a table showing data and control signals received and sent by a controller in the engine shown in FIG. 1.

FIG. 3 is a schematic view of a logic circuit in the controller of FIG. 2.

FIGS. 3A-3B are a series of schematic views showing in numbered sequence steps of operation of the engine shown in FIG. 1.

FIG. 4 is a table of exemplary design parameters for the engine shown in FIG. 1.

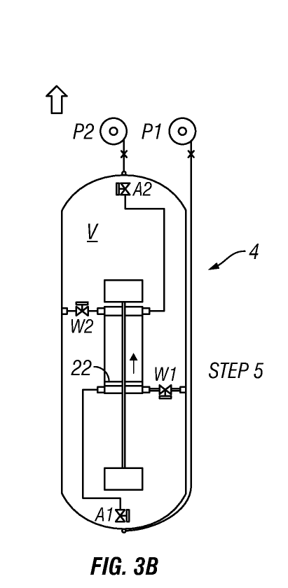

FIG. 5 is a schematic elevation view of a gravity driven hydraulic engine according to a second embodiment of the present invention.

FIG. 6 is a schematic elevation view of a gravity driven hydraulic engine according to a third embodiment of the present invention.

### DETAILED DESCRIPTION OF PREFERRED EMBODIMENTS

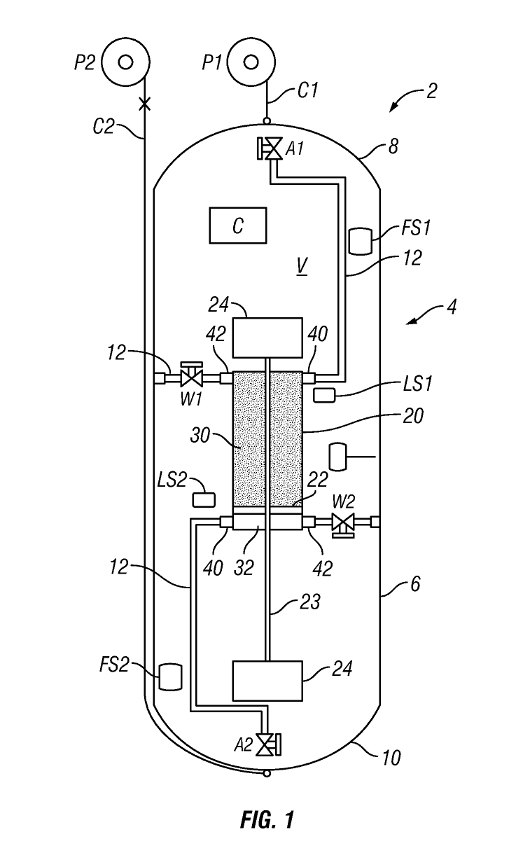

Referring to FIG. 1, a gravity driven hydraulic engine 2 includes an outer shell or capsule 4 connected via first and second cables C1, C2 and first and second pulleys P1, P2 to a gearbox driving an output shaft (not shown). The output shaft turns a mechanical load, for example a pump (also not shown).

The capsule 4, depicted in FIG. 1 includes a hollow cylinder portion 6 with first and second domed caps 8, 10 on either end. As will be readily appreciated, however, the capsule 4 can be spherical or any other shape. The capsule 4 is substantially symmetrical about a midplane disposed between two cable attachment points, so that the capsule 4 can be suspended from either attachment point for oscillating rotation in water. Preferably, the capsule has a smooth outer surface, and is shaped so as to provide minimal resistance to travel in water.

The capsule 4 is watertight and encloses an inner volume V containing piping 12, wiring, a controller C, a pressure switch, and one or more hydro-pneumatic working cylinders 20 fastened to the capsule by a frame (not shown), which can include threaded rods for clamping on the domed caps. The capsule is penetrated at or near the midplane by a pressure sensing port and by water valves W1, W2; additional watertight bulkhead connectors may supplement the water valves as required by external controllers.

The piping 12 connects each water valve W1, W2 to an end of the one or more working cylinders 20 and connects the pressure switch to the pressure sensing port. The wiring connects the controller C to the pressure switch, the water valves, and other components further described in detail below. The pressure switch generates an “on” signal only when the capsule 4 is at or below operating depth; otherwise the pressure switch returns an “off” signal.

The working cylinder 20 houses a piston 22, which divides the cylinder into upper 30 and lower chambers 32. The piston 22 includes driving weights 24, and exerts compressive force against one of the upper 30 and lower chambers 32. The piston 22 is shown disposed approximately midway along a double-ended rod 23, which penetrates each end of the cylinder 20 and carries the driving weights 24 at each end. While a rod 23 may be utilized, it is also be possible to utilize rodless cylinders. Such cylinders can include band cylinders or magnetic rodless cylinders.

When rodless cylinders are employed, the capsule or shell may be of a reduced size. This reduced size minimizes the amount of travel when the capsule is flipped during operation.

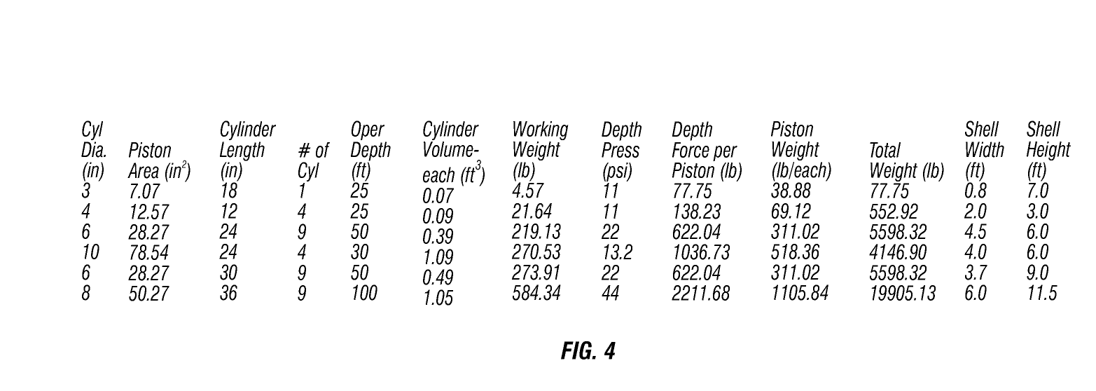

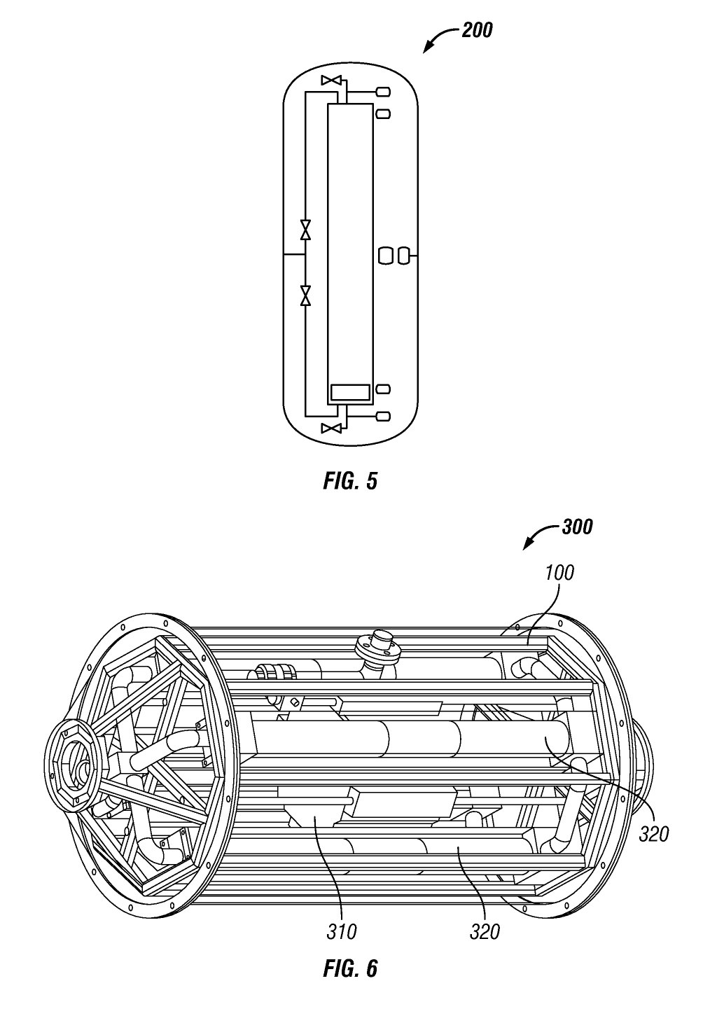

In an alternative embodiment shown in FIG. 5, the driving weights ride on guide rails and bushings that mitigate lateral forces on rods, particularly at their far ends of travel, so as to reduce wear on seals of the cylinder. Alternatively, as shown in FIG. 6, the piston can be connected to the driving weight by a cord-and-pulley system, as in a rodless piston-cylinder. The cord-and-pulley system conserves space relative to the double-ended rod shown in FIG. 1.

In particular, the embodiment disclosed in FIG. 6 includes multiple rodless piston/ cylinders 320 that are operatively connected to a centrally mounted weight 310.

Turning back to FIG. 1, the piston 22 preferably fits tightly against an inner surface of the cylinder 20 with low contact friction. The cylinder 20, the frame, the piping 12, the piston 22, and the driving weights 24 are disposed within the capsule 4 such that the capsule center of mass is consistently disposed between the piston 22 and the midplane.

Each chamber 30, 32 of the working cylinder 20 has at least one air opening 40 and at least one water 42 opening formed in the corresponding cylinder end, and has at least one limit switch LS1, LS2 disposed near the point where the piston 22 most closely approaches the cylinder end. Each limit switch produces an ON signal only when the piston is adjacent the corresponding end of the working cylinder. The piping 12 connects the cylinder water opening 42 to a corresponding water valve W1, W2 penetrating the capsule 4.

The piping 12 also connects each cylinder 20 air openings 40 to a corresponding air valve A1, A2, which opens on the capsule inner volume. Between each air valve A1, A2 and the corresponding cylinder air opening 40 is a float switch FS1, FS2. Each float switch produces an ON signal only when the adjacent chamber is flooded with water, or when the adjacent chamber is the lower chamber of the working cylinder.

The frame 100 (FIG. 6) is attached to the inner surface of the capsule 4 and supports the cylinder(s) 20, the piston weight guide rails (if employed), and the valves, piping 12, and controller.

Operation of the inventive engine is controlled by a control mechanism, which includes the cables and pulleys mentioned above and a valve system. The valve system is operatively connected to the controller C via wiring. In particular, the controller C receives input signals from the float switches, limit switches, and pressure switch and sends signals to actuate the air valves and water valves. Alternatively, the controller can send and/or receive pneumatic, hydraulic, acoustic, optical, or other wireless signals. The controller can be connected to the gearbox for engaging and disengaging the pulleys; alternatively, the gearbox can be actuated by load exerted on the pulleys, as further discussed in detail below.

Each float switch FS1, FS2 sends an ON signal to the controller only when the corresponding working cylinder chamber 30, 32 is flooded with water. Each limit switch sends an ON signal to the controller only when the piston 22 is adjacent to the limit switch. The pressure switch toggles to send an ON signal to the controller when the capsule is at or below operating depth, and toggles to send an OFF signal when the capsule returns to the water surface.

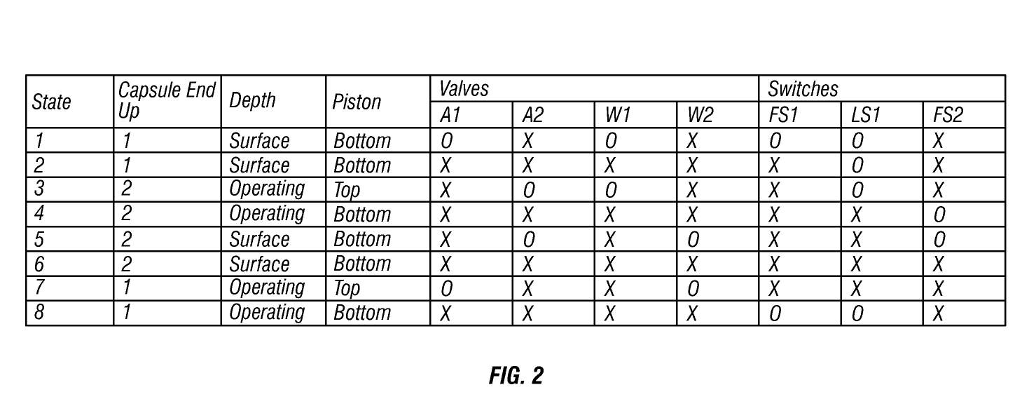

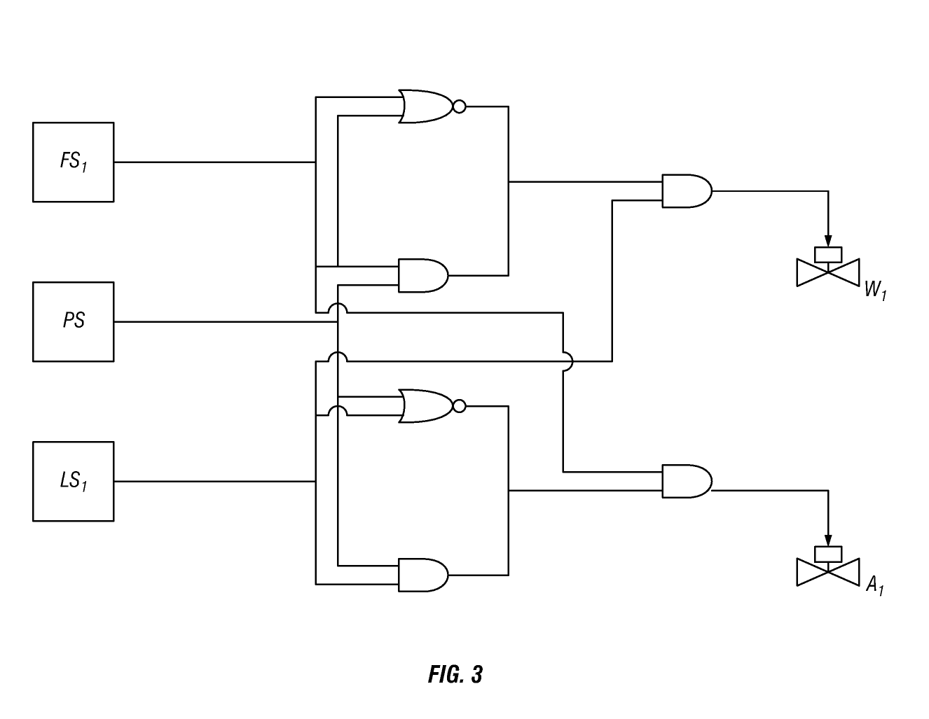

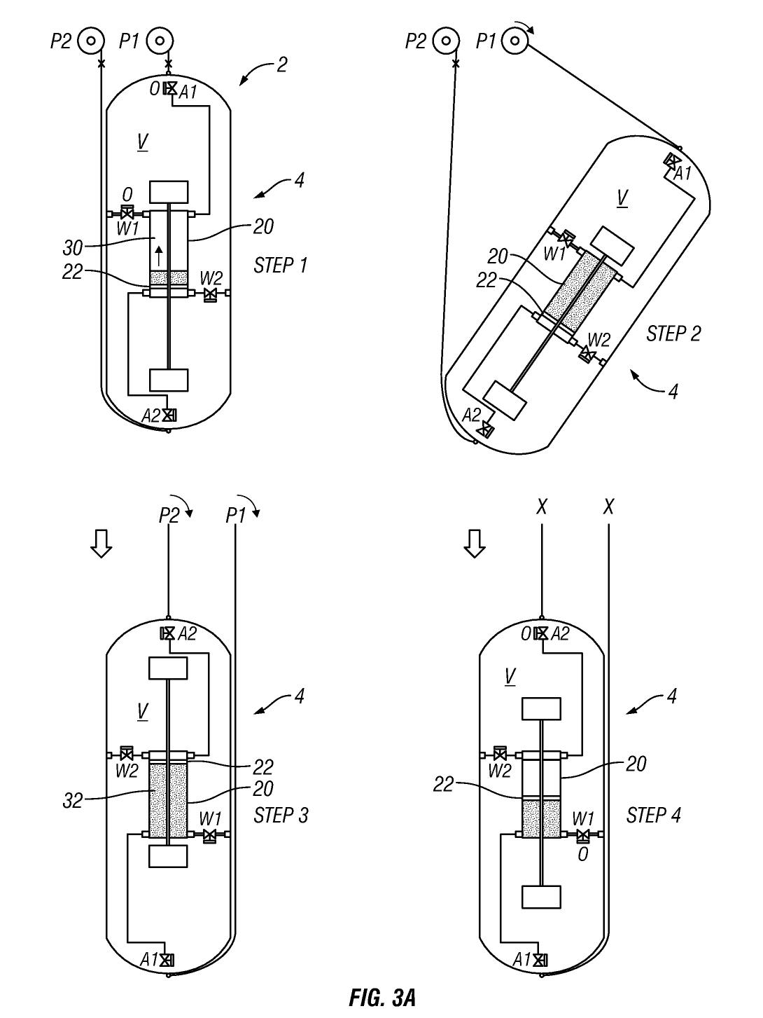

Referring to FIGS. 2 and 3, the controller sends ON or OFF signals (O and X) to each of the air valves A1, A2 and water valves W1, W2 in response to signals received from the float switches FS1, FS2, the limit switches LS1, LS2, and the pressure switch PS. For example, in the embodiment shown in FIG. 1, the controller sends an OFF signal to air valve Al unless limit switch LS1 and pressure switch PS1 both are sending the same signal (ON or OFF) to the controller; in that case, the controller sends air valve A1 the signal from float switch FS1 (ON or OFF). Similarly, the controller sends an OFF signal to water valve W1 unless float switch FS1 and pressure switch PS both are sending the same signal (ON or OFF) to the controller; in that case, the controller sends water valve W1 the signal from limit switch FS1 (ON or OFF). The air and water valves are configured to be normally closed and to open only while receiving an ON signal. The controller logic is configured essentially identically for the double-ended piston rod embodiment shown in FIG. 5 and somewhat differently for the cord-and-pulley embodiment shown in FIG. 6, as will be apparent to one of ordinary skill.

The capsule 4 dimensions are determined by the weight of the engine's internal components (cylinder, weights, piping, etc.), such that when placed in water the capsule is slightly positive buoyant overall. Desired buoyancy may vary slightly depending on the mode of operation, though the principle that the displacement of the capsule is nearly equal to the weight of its internal components is true in most applications. The capsule domes 8 are attached to the center cylinder 6 by gasket and flange (not shown), or through compression of each dome on a gasketed end surface of the cylinder using a center threaded rod attached through the point of the dome and connected to the frame.

The piston weights 24 should be constructed from high-density metals to conserve space and allow for maximum air volume within the capsule, as some change in volume during operation of the cylinder(s) will take place and should not produce a change in pressure that would adversely affect the device operation. The weights should be attached in a “low profile” manner, to allow construction of the capsule to be as compact as possible. By attaching weights in parallel to the piston rod with clearance provided for the cylinder body, minimal capsule height can be achieved. Due to the rotational aspect of device operation, this will preserve travel distance when used in a manner where work output is a function of travel.

Referring back to FIG. 1, each of the pulleys P1, P2 is attached via a pulley shaft to a gearbox having a shift mechanism that allows the pulley shafts alternately to engage the output shaft or to disengage and spin free in either direction (not shown). The cable C1 riding in the first pulley P1 is connected to the first domed cap of the capsule shell, and the cable C2 riding in the second pulley P2 is connected to the second domed cap of the capsule shell. The gearbox shift mechanism is arranged so that disengagement from either pulley engages the other pulley. The shift mechanism can be arranged for make-before-break or break-before-make operation depending on desired performance of the engine, as will be apparent to one of ordinary skill.

Many elements of the device construction are important to realizing the maximum output. All materials should be as lightweight as possible, while still providing adequate structural integrity, thereby allowing the maximum amount of weight to be applied to the piston(s). The outer shell can be constructed from plastic, carbon fiber, or a lightweight metal. The external surface of the shell should be smooth to allow for reduced resistance while traveling in water. The top and bottom of the cylinder should be dome shaped for the same reason. Alternatively, a spherical device shell may be used. The weights should have stops on their support frame to avoid internal cylinder parts from contacting at the ends of travel. The internal valves and piping should be the maximum size possible, to ensure quick refill of, and discharge from, the cylinder. With that, multiple ports on each end of the cylinder can be used to maximize flow. This will quicken the overall operation of the device. Volume of the internal cylinder(s) determines the device's operating force.

Weights 24 are attached to each end of the piston rod 23 and total the force required to overcome water pressure applied to the piston at operating depth. The outer shell dimension displaces a volume of water such that it has slight overall positive buoyancy when submerged. By placing the air valves at the ends of the device, they should be above the water line when the device is positively buoyant. This design allows for filling to be determined by a timing mechanism, as the rate of filling is constant. Alternatively, float switches may be used, or another method, to shut the valves once the cylinder is full. This would allow the air valves to be located elsewhere within the device.

Each pulley P1, P2 is connected to a shaft that has a gear on the other end and is housed within a gearbox (not shown). A shift mechanism alternates engagement with each pulley's corresponding gear to a single output driveshaft, which is used to provide output. The shift mechanism that may be operated using mechanical, electrical, or other means. A weight-actuated shift mechanism can be employed to alternate the pulley that is engaged to the external driveshaft. As the cylinder fills at the surface to begin the cycle, the device's weight increases. At the predetermined weight sensed on the cable, the shift mechanism can be actuated to disengage the pulley connected via cable to the top of the device, and thereby engage the pulley connected via cable to the bottom of the device.

Cables C1, C2 are neutrally buoyant and may contain wiring to power electrical solenoids and/or provide control circuitry. In all applications, air and water valves are bidirectional, such that they block pressure in both directions when closed, e.g. a ball valve.

In operation, as shown in FIGS. 3A-3B, the piston 22 will alternate between having water and air contacting its surfaces. When the water valve W1, W2 connected to the cylinder 20 is open, external water pressure is felt on the piston. Internal air pressure of the capsule 4 is felt on the opposite side of the piston 22 during operation, and varies from atmospheric pressure by the change in volume of the cylinder when filled with water.

The engine 2 is controlled by cyclically actuating the valves and pulleys in response to actuating signals provided by the triggering sensors. The components changing state as determined by the triggering element are indicated in bold at each step of an engine cycle. Each state is determined by the orientation of the device (numbered end on top or bottom), depth, valve positions, and location of piston within the cylinder. Pulley states are Engaged (E) or Disengaged (D), and are changed simultaneously by a single shift lever in the gearbox. Valves and switches are indicated as Open (O) or closed (X).

Referring to Step 1, the engine 2 is initially slightly buoyant when placed in water. The piston 22 is at the lower end of the cylinder, so that the cylinder upper chamber 30 occupies most of the cylinder and is filled with air. The upper air valve A1 and water valve W1 are opened to flood the cylinder upper chamber 30 with water while exhausting air from the cylinder upper chamber 30 to the capsule inner volume V. The weight added by the water in the cylinder 20 becomes the working weight of the engine 2, as negative buoyancy is achieved. The upper valves are shut by the logic module when the sensor indicates the cylinder is flooded.

With the engine 2 negatively buoyant, the pulley P1 with cable C1 attached to the top of the capsule is released, allowing the capsule to sink as the top end cable unspools. This is depicted at Step 2 of FIG. 3A. The pulley P2 with cable C2 attached to the bottom of the capsule 4 remains locked, causing the capsule 4 to pivot downward around the bottom cable attachment point as the capsule sinks.

Referring to Step 3, with the capsule inverted, the piston 22 is now held at the upper end of the cylinder 20 by the water trapped in the lower chamber 32 of the cylinder 20. The pulley P2 with cable C2 attached to what was the bottom of the capsule 4 is unlocked and engaged with the output shaft, so that the weight of the capsule 4 turns the output shaft as the capsule sinks. The output shaft torque can be used to drive a generator or other load.

When the device sinks to its operating depth, as determined by the length of the cable, rotation of the pulley stops (Step 4). The upper air valve and lower water valve are opened, allowing the weights attached to the piston 22 to overcome the force applied by external water pressure at its operating depth. The deeper the operation of the device, the more weight that is required. Likewise, the larger the piston diameter, the larger the weight required to overcome external water force.

As the piston travels to the bottom of the cylinder, water is ejected from the device, increasing its overall buoyancy. When the piston 22 reaches the end of its travel, the upper air valve and lower water valve are shut. The device is positively buoyant and floats to the surface. The cable slack is retracted by a small counterweight at the other end of the cable, by a spring-loaded reel, or by a second device that begins its descent while the first ascends.

Referring now to FIG. 3B, at the surface, the state of the capsule 4 is the same as the initial state of the device when placed in the water, though inverted. Due to the symmetrical nature of its construction, the process repeats as described above.

As indicated at above, it is anticipated that two devices will be operated in tandem, such that while one device is sinking, the other is rising. This has the benefit of doubling the work output, providing a more continuous output, facilitating the retraction of cabling (if used), and increasing the overall speed of operation as the rising device will ascend more rapidly with minimal positive buoyancy. Several devices may be chained in this manner to provide the most constant output, as determined by the speed of operation of each.

There are two main aspects to controlling the engine's operation: internal valve operation, and external support/rotation operation.

Valves have actuators that cycle in the sequence: A1+W1→A2+W1→A2+W2→A1+W2. Actuators may be electric solenoids, which require either an internal power supply or power and control circuitry from the surface, routed with wires through bulkhead connectors in the capsule shell. Control signals can be produced using mechanical limit or pressure sensitive switches, or by timer operation. Valve actuators also can be pneumatic or mechanical. Air pressure can be obtained using an auxiliary cylinder within the device that also has a double rod and weight configuration. As the device operates, the piston will travel and compress small bursts of pressurized air required to drive the actuators.

Pulleys and cables are one method for controlling the operation of the device and providing usable output (work). Pulleys are connected to rods that are connected to a gearbox and alternate between engaged and clutched (free spinning) state. When the device is falling under weight, the attached cable drives the engaged pulley to provide rotational force at the output shaft. When the device is rotating to reset itself prior to the drive phase, the pulley with cable attached to the top point on the device is disengaged and allowed to spin freely. At the same time, the pulley with its cable attached to the bottom of the device is engaged to allow for output during the second phase of the cycle.

Referring generally to FIGS. 2 and 3A-3B, the following sequence is required for device operation, with the initial state (0) being the device is in water, all valves are closed (de-energized), the piston is at the bottom (#2 end) of the cylinder, and the device is held in place with the number 1 end of the capsule upward, pulley 1 engaged and pulley 2 disengaged. Table 1 lists each state and corresponding valve/switch/pulley condition.

With power applied to the control circuit, air valve A1 and water valve W1 open, allowing water to fill the cylinder. The pressure switch (PS) is open due to low pressure sensed at the surface position of the capsule, while limit switch LS2 is closed to indicate the piston is at the bottom (#2 position) of the cylinder, indicating the refill sequence conditions are met. Float switch FS2 is closed, simply as the result of the capsule being inverted.

When the cylinder is full, float switch FS1 is triggered, closing air valve A1 and water valve W1. The gearbox is shifted to engage pulley P2 and disengage pulley P1. Tension on the cable attached to the top (#1 end) of the capsule is released, allowing gravity to force the rotation of the device as tension is applied to the cable attached to the bottom (#2 end) of the capsule. The device continues downward with the #2 end of the capsule on top to its operating depth, as determined by the length of the cable #2.

At operating depth, pressure switch PS is activated and triggers air valve A2 and water valve W1 to open, allowing the weighted piston to travel to the bottom (#1 end) of the cylinder, ejecting water from the device and allowing the cylinder to fill with air from the outer chamber.

At the bottom of piston travel, limit switch LS1 is closed and triggers air valve A2 and water valve W1 to close. With the water volume from the cylinder expelled, positive buoyancy is achieved and the device travels to the surface. Technically, A2 may remain open between this state and the next.

As the capsule arrives at its surface position, pressure switch PS is deactivated, triggering air valve A2 and water valve W2 to open. This allows water to fill the cylinder from the top (#2 end). When the cylinder is full, float switch FS2 is triggered, closing air valve A2 and water valve W2. The gearbox is shifted to engage pulley P1 and disengage pulley P2. Tension on the cable attached to the top (#2 end) of the capsule is released, allowing gravity to force the rotation of the device as tension is applied to the cable attached to the bottom (#1 end) of the capsule. The device continues downward with the #1 end of the capsule on top to its operating depth, as determined by the length of the cable #1.

At operating depth, pressure switch PS is activated and triggers air valve A1 and water valve W2 to open, allowing the weighted piston to travel to the bottom (#2 end) of the cylinder, ejecting water from the device and allowing the cylinder to fill with air from the outer chamber. At the bottom of piston travel, limit switch LS2 is closed and triggers air valve A1 and water valve W2 to close. With the water volume from the cylinder expelled, positive buoyancy is achieved and the device travels to the surface. Technically, A1 may remain open between this state and the next.

One advantage of the present invention is that the gravity driven hydraulic engine requires no fuel, and can be operated in any sufficiently deep body of water, including artificial bodies of water such as water towers. Although some input energy may be required for driving electric solenoid valves and control circuitry, control inputs remain substantially constant with device scaling. Since no fuel is burned, the gravity driven engine produces no emissions (a clean alternative energy source). The engine is massively scalable, and constantly available, unlike solar, wind, and wave energy devices. The engine can be constructed using basic mechanical components. The engine operates with minimal noise and is effectively silent.

The engine can be scaled to function in many applications. These include residential applications where smaller installations may provide energy independence for residences, with units in an underground tank, as part of a physical structure (i.e. faux chimney), or as an external element (i.e. faux grain silo). Industrial applications are also possible with complexes near natural bodies of water, or with space enough to construct underground or above ground tanks can leverage multiple devices to power industrial applications. Moreover, commercial applications such as offshore platforms which allow for “farms” of large-scale versions of the device that function to produce commercial energy are also possible. Floating platforms, offshore drilling platforms, waterborne windmill arrays, etc. are all potential operating platforms for large-scale commercial applications.

While the preferred embodiment has been described above, several alternative modes of operation are possible, and may be used together. In all cases, the speed of device operation is proportional to its work output. Therefore, use of low friction pistons, high volume ports, piping, and valves, streamlined external surfaces, etc. are all important design aspects. For example, oscillator: travel of the device rotates the pulleys, which may be used to drive a generator, pump, etc. Note that an alternative mode of operation would allow for pulleys on the top and bottom of the device travel, thereby allowing for output in both directions. In this case, one half of the force would be provided in each direction. As another example, pump: excessive weight may be applied to the piston for its operating depth, allowing high-pressure water to be utilized through lines attached to the outer shell up to the surface. In this water pump mode, a turbine at the surface is driven to supply the work output. As a third example, hybrid: Initial flooding of the cylinder may be minimal, so as to cause sinking to a depth where the remainder of the cylinder volume is added at high pressure. This mode allows for the leverage of this high-pressure stream of water, which may turn a turbine. As a fourth example, recovery: As a mass will travel with less resistance in air, an alternative mode of operation for the device is as a recovery machine. In this mode, a mass is dropped in air to maximize power output. The device is connected to the mass using a pulley and cable such that it raises the mass in air as it sinks in water. The working weight of the device must therefore be greater than the weight of the mass in air.

As a further example, the net work provided by the engine may be increased by increasing the aggregate volume of the cylinder(s), as work output is directly proportional to the weight of the water volume in the cylinder: Increasing the diameter of the cylinder increases the area of the piston and therefore the force of water pressure at depth. This necessitates the use of more weight on the piston rod ends. Increasing the length of the cylinder will increase the volume of water without requiring a change in weights, but increases the overall length of the device.

Also, a second device can be used in opposition to double energy output and retract cables. Otherwise, a spring retraction mechanism on the pulley or counterweight at the opposite end of each cable can be used. Similarly, an auxiliary piston may be used within the capsule to provide compressed air for use with pneumatic valve operators, along with control logic, using the same double weight concept.

As further examples, a non-collapsible breather line may be used to allow air from the surface to be used instead of using only the air volume within the capsule shell. This would allow the air pressure within the capsule to always be atmospheric. The airline could be integrated into the main attachment cables, along with the control circuitry.

An alternative to pressure switch activation in the control circuit would be to use limit switches, activated by cable position, or by external position sensors. An alternative to pulleys and cable, particularly for shallow operating depths, would be a shaft system with gear drive, where the device would have two pivot points near the top and bottom to use in rotation during the reset portion of the cycle. Cables may be connected to points other than the top and bottom of the outer shell, so long as they are below the vertical center of gravity or the device is weighted such that rotation is possible during the reset phase. Locating pivot points above and below the ends will preserve travel to maximize output of the device. As an alternative to multiple water valves, a single 3-way valve can control flow between the two cylinder ends and a single exterior water port disposed near the capsule midplane.

Although this invention has been shown and described with respect to the detailed embodiments thereof, it will be understood by those skilled in the art that various changes in form and detail thereof may be made without departing from the spirit and the scope of the invention.

I claim:

1. A gravity driven hydraulic engine, said engine comprising:
an outer shell having first and second ends and an inner cavity that is substantially impervious to water;
at least one cylinder, said cylinder having opposing first and second ends, said cylinder being located within said inner cavity;
a weighted piston within said cylinder, said weighted piston dividing said cylinder into first and second chambers, said weighted piston being slidably movable within said cylinder; and
wherein said first and second chambers alternately fill with liquid and air to cause said engine to move in a first direction from a first position, said movement generating energy output, and to move in a second direction to return to said first position.

2. The gravity driven hydraulic engine of claim 1, wherein said engine operates in an aqueous environment.

3. The gravity driven hydraulic engine of claim 2, wherein said engine further comprises a control mechanism for controlling the movement of said engine.

4. The gravity driven hydraulic engine of claim 3, wherein said control mechanism further comprises:
a first air valve operatively connected to said first end of said cylinder;
a first water valve operatively connected to said first end of said cylinder and to an exterior surface of said outer shell;
a second air valve operatively connected to said second end of said cylinder; and
a second water valve operatively connected to said second end of said cylinder and to an exterior surface of said outer shell.

5. The gravity driven hydraulic engine of claim 4, wherein said control mechanism further comprises:
a first float switch located between said cylinder and said first air valve;
a second float switch located between said cylinder and said second air valve; and
wherein said first and second float switches detect whether said cylinder is full of water.

6. The gravity driven hydraulic engine of claim 5, wherein said control mechanism further comprises:
a first limit switch located proximate said first end of said cylinder;
a second limit switch located proximate said second end of said cylinder; and
wherein said first and second limit switches detect full travel of said piston in opposite directions within said cylinder.

7. The gravity driven hydraulic engine of claim 6, wherein said control mechanism further comprises:
a pressure switch, said pressure switch detecting water pressure external to the shell.

8. The gravity driven hydraulic engine of claim 4, wherein said engine further comprises:
a first pulley operatively connected to said first end of said outer shell via a first cable;
a second pulley operatively connected to said second end of said outer shell via a second cable; and
wherein said first and second pulleys may be selectively braked, and wherein movement of said engine rotates at least one of said pulleys to generate energy output.

9. The gravity driven hydraulic engine of claim 1, wherein said piston is affixed to a rod, said rod having opposing weighted ends.

10. A gravity driven hydraulic engine for use in an aqueous environment, said engine comprising:
a symmetrical outer shell having first and second ends and an inner cavity that is substantially impervious to water;
at least one cylinder, said cylinder having opposing first and second ends, said cylinder being located within said inner cavity;
a weighted piston within said cylinder, said weighted piston dividing said cylinder into first and second chambers, said weighted piston being slidably movable within said cylinder;
a first air valve operatively connected to said first end of said cylinder;
a first water valve operatively connected to said first end of said cylinder and to an exterior surface of said outer shell;
a second air valve operatively connected to said second end of said cylinder;
a second water valve operatively connected to said second end of said cylinder and to an exterior surface of said outer shell; and
wherein said first air valve and first water valve and second air valve and second water valve alternately open to fill said cylinder with water and air to cause said engine to rotate, said rotation generating energy output.

11. The gravity driven hydraulic engine of claim 10, wherein said engine further comprises:
a first pulley operatively connected to said first end of said outer shell via a first cable;
a second pulley operatively connected to said second end of said outer shell via a second cable; and
wherein said first and second pulleys selectively rotate with said shell to extract energy output from said engine.

12. A method of generating energy output in an aqueous environment, said method comprising the steps of:
placing a hydraulic engine in an aqueous environment in a first position;
creating a negative buoyancy within said hydraulic engine to submerge said engine in said aqueous environment;
allowing said hydraulic engine to travel in said aqueous environment to a predetermined depth, wherein said travel generates energy output.

13. The method of claim 12 wherein said step of creating a negative buoyancy comprises:
opening a valve in said engine to let water into a cylinder within said engine; and
closing said valve when a predetermined amount of water has entered said cylinder.

14. The method of claim 13 wherein said method further comprises the step of rotating said submerged engine, wherein said rotation comprises the steps of:
releasing a first pulley and a first cable secured to a first end of said engine while holding a second pulley and second cable secured to a second opposite end of said engine in a fixed position; and
wherein the release of said first pulley allows said submerging engine to rotate until said engine is inverted from said first position.

15. The method of claim 14 wherein said method further comprises the step of:
releasing said second pulley to allow said engine to travel in said inverted position to a predetermined depth within said aqueous environment.

16. The method of claim 15 wherein said method further comprises the step of:
opening said valve to allow water to exit said cylinder; opening a second valve to allow air to enter said cylinder;
forcing water out of said cylinder through said valve.

17. The method of claim 16 wherein said water is forced out of said valve by at least one weighted piston.

18. The method of claim 16 further comprising the step of:
allowing said engine to return to a surface of said aqueous environment once water has been forced out of said cylinder through said valve and positive buoyancy has been attained.

19. The method of claim 12 wherein said travel of said engine rotates pulleys to generate energy output.

20. The method of claim 19 wherein said pulleys are operatively connected to a generator.
